(19) United States
(12) Patent Application Publication
(10) Pub. No.: US 2019/0283268 A1
(43) Pub. Date: Sep. 19, 2019

(54) WOOD PLANING MACHINE HAVING BOTH MANUAL AND AUTOMATIC PLANING WOOD FUNCTION

(71) Applicant: Bor-Yann Chuang, Taichung (TW)

(72) Inventor: Bor-Yann Chuang, Taichung (TW)

(21) Appl. No.: 15/922,583

(22) Filed: Mar. 15, 2018

(51) Int. Cl. B27C 1/04

(52) U.S. Cl. CPC B27C 1/04; B27C 1/12

(57) ABSTRACT

A wood planing machine having both manual and automatic planing wood function includes a fundamental base provided with a first working platform and a second working platform. The fundamental base has two sides respectively provided with a guide unit, and a wood planing device is combined with the guide units. Thus, when the wood planing device is pushed to move toward the second working platform from the first working platform, the wood positioned on the first working platform will be planed to form a first flat surface. Then, the wood planing device is positioned at the second working platform, and the wood is turned over to have the wood planing device automatically planing the wood to form a second flat surface. Therefore, this invention is able to integrate efficacy of a manual wood planer and an automatic wood planer and enhance safety in use of the wood planning machine.

### BACKGROUND OF THE INVENTION

### 1. Field of the Invention

This invention relates to a wood planing machine, particularly to one having both manual and automatic planing wood function.

### 2. Description of the Prior Art

Since most part of wood is warped before being planed; therefore, when wood is to be planed with parallel precision, firstly, a hand press wood planer has to be used to have the wood planed to form a first flat surface as a criterion and then, an automatic wood planer is employed to carry out automatic feeding and plane the wood to form a second flat surface for enhancing parallel precision of the wood.

However, the planing wood method mentioned above has the following defects:

1. It is impossible to plane a warped wood and form parallel precision of the wood by singly employing an automatic wood planer; therefore, a consumer has to purchase two kinds of wood planers, thus high in purchasing cost;

2. The cutting tool of the hand press wood planer is installed beneath the wood, so the wood is likely to spring back and cause danger;

3. In case the wood is too thin, when carrying out planing wood with a hand press wood planer, a user's hands are apt to be injured; and

4. The wood to be planed cannot be too long; otherwise, when a user's hands press the wood, application of force may be uneven and as a result, the feeding end and the discharge end of the wood will cause disparity.

Therefore, in view of above-mentioned drawbacks, the inventor of this invention thinks that it is necessary how to reduce purchasing cost for consumers and integrate the advantage of both the conventional manual wood planer and automatic wood planer to enhance safety in use of a wood planning machine and hence devises this invention.

### SUMMARY OF THE INVENTION

The objective of this invention is to offer a wood planing machine having both manual and automatic planing wood function, able to integrate efficacy of a manual wood planer and an automatic wood planer and plane a warped wood with parallel precision for enhancing safety in use of the wood planing machine.

The wood planing machine having both manual and automatic planing wood function in the present invention includes a fundamental base and a wood planing device. The fundamental base is provided with a first working platform and a second working platform along a major axis and has two sides, which are parallel to the major axis, respectively provided with a guide unit, and further disposed with a positioning member at a location adjacent to the second working platform. The wood planing device consists of a housing, a moving member and a fixing member. The housing has a bottom side installed with a cutter arbor corresponding to both the first working platform and the second working platform. The moving member is provided beneath the housing to correspond with the guide units and set with the fixing member to correspond with the positioning member of the fundamental base. The positioning member of the fundamental base can be positioned at the fixing member so that the wood planing device can be positioned with the positioning member of the fundamental base through the fixing member.

The wood planing machine having both manual and automatic planing wood function of this invention is first to have a piece of wood placed on the first working platform and then, the wood planing device is pushed to move toward the second working platform to have the wood planed to form a first flat surface as a criterion. Subsequently, after the wood planing device is positioned with the positioning member of the fundamental base by the fixing member and the wood is turned over, the wood planing device will carry out planing automatically to have the wood planed to form a second flat surface. By so designing, the wood planing machine of this invention is able to integrate efficacy of the conventional hand press wood planer and automatic wood planer, enhance parallel precision of the wood and increase security in use of the wood planing machine.

### BRIEF DESCRIPTION OF DRAWINGS

This invention will be better understood by referring to the accompanying drawings, wherein: FIG. 1 is a combination perspective view of a preferred embodiment of a wood planning machine having both manual and automatic planning wood function in the present invention;

FIG. 2 is a partial exploded perspective view of the preferred embodiment of the wood planning machine having both manual and automatic planning wood function in the present invention, showing that a first position-limiting member is to be combined with a wing plate;

FIG. 3 is a partial cross-sectional view of the preferred embodiment of the wood planning machine having both manual and automatic planning wood function in the present invention, showing a state that the first position-limiting member is combined with the wing plate;

FIG. 4 is a partial exploded perspective view of the preferred embodiment of the wood planning machine having both manual and automatic planning wood function in the present invention, showing an exploded state of a second working platform;

FIG. 5 is an exploded perspective view of the preferred embodiment of a guide unit and a positioning member in the present invention;

FIG. 6 is a cross-sectional view of the preferred embodiment of a wood planning device in the present invention;

FIG. 7 is an exploded perspective view of the preferred embodiment of the guide unit and a moving member in the present invention;

FIG. 8 is a schematic view of the preferred embodiment of the wood planning machine having both manual and automatic planning wood function in use in the present invention, showing that a piece of wood is placed on a first working platform;

FIG. 9 is a partial magnified view of FIG. 8;

FIG. 10 is a cross-sectional view of the preferred embodiment of the wood planning machine having both manual and automatic planning wood function in the present invention, showing a state that the wood planing device is positioned with the positioning member; and

FIG. 11 is a schematic view of the preferred embodiment of the wood planning machine having both manual and automatic planning wood function in use in the present invention, showing that the wood is placed on a second working platform.

### DETAILED DESCRIPTION OF THE PREFERRED EMBODIMENT

A preferred embodiment of a wood planing machine 100 having both manual and automatic planing wood function in the present invention, as shown in FIG. 1, includes a fundamental base 10 and a wood planing device 20 as main components combined together.

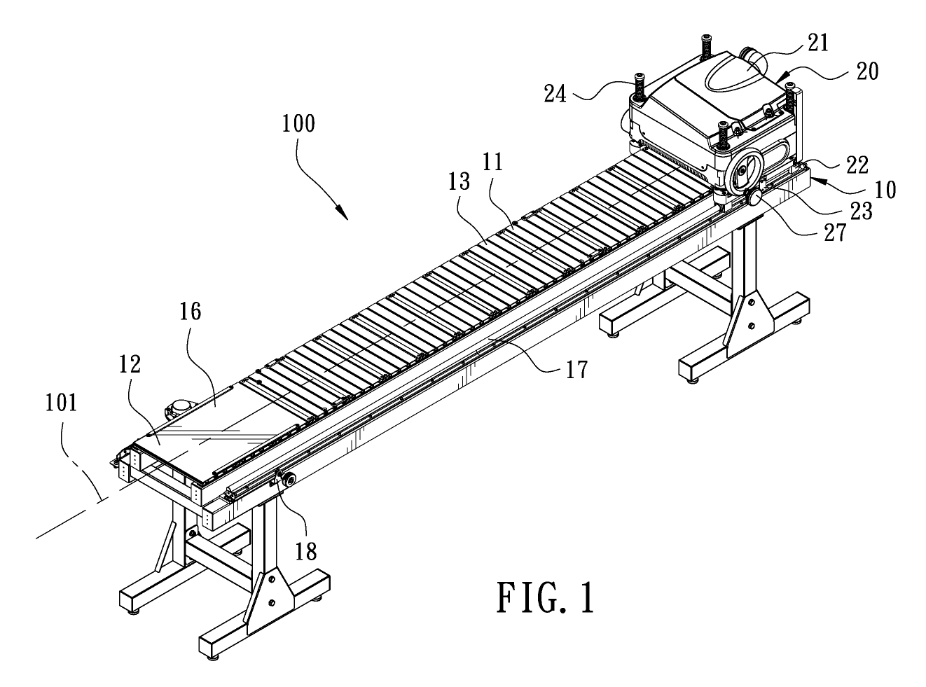

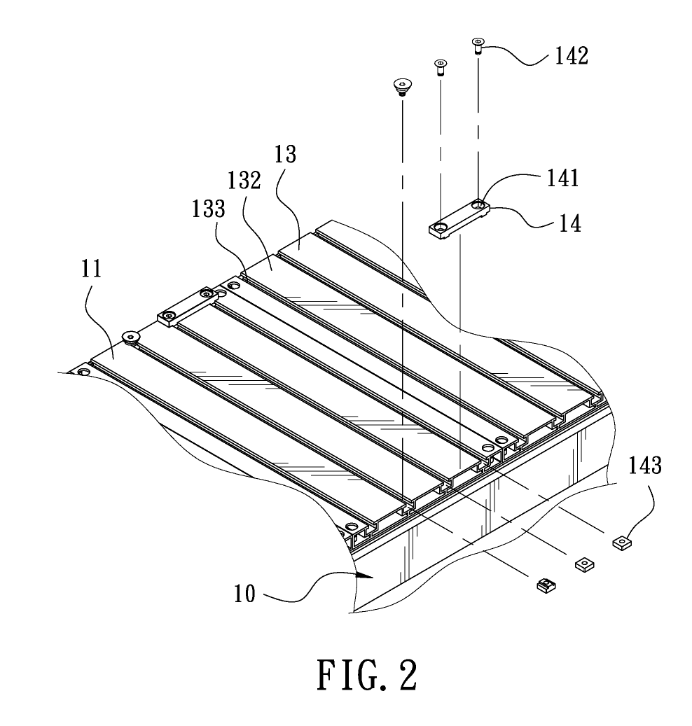

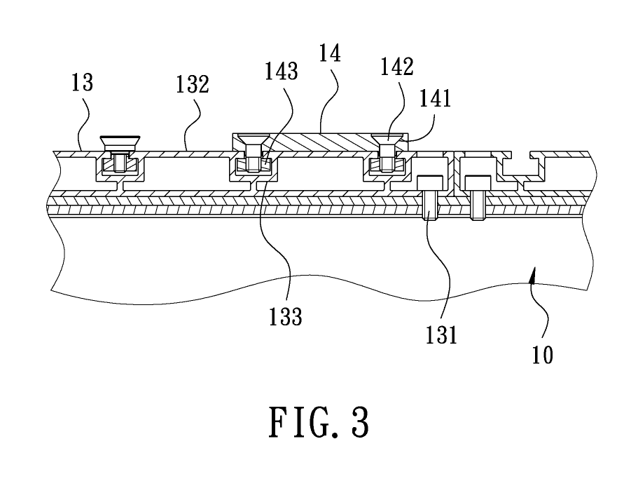

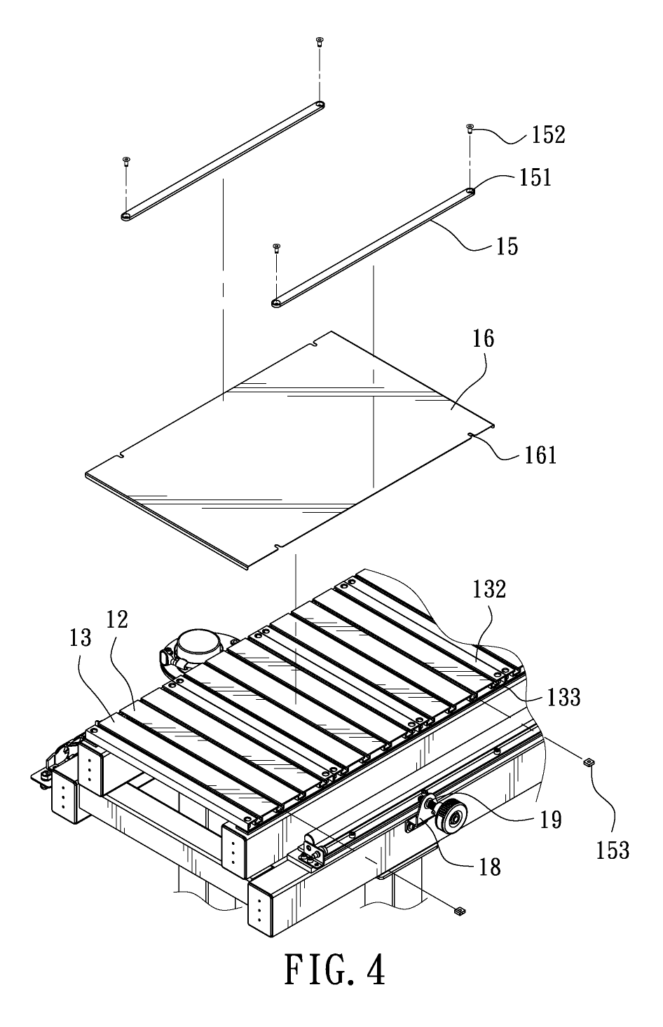

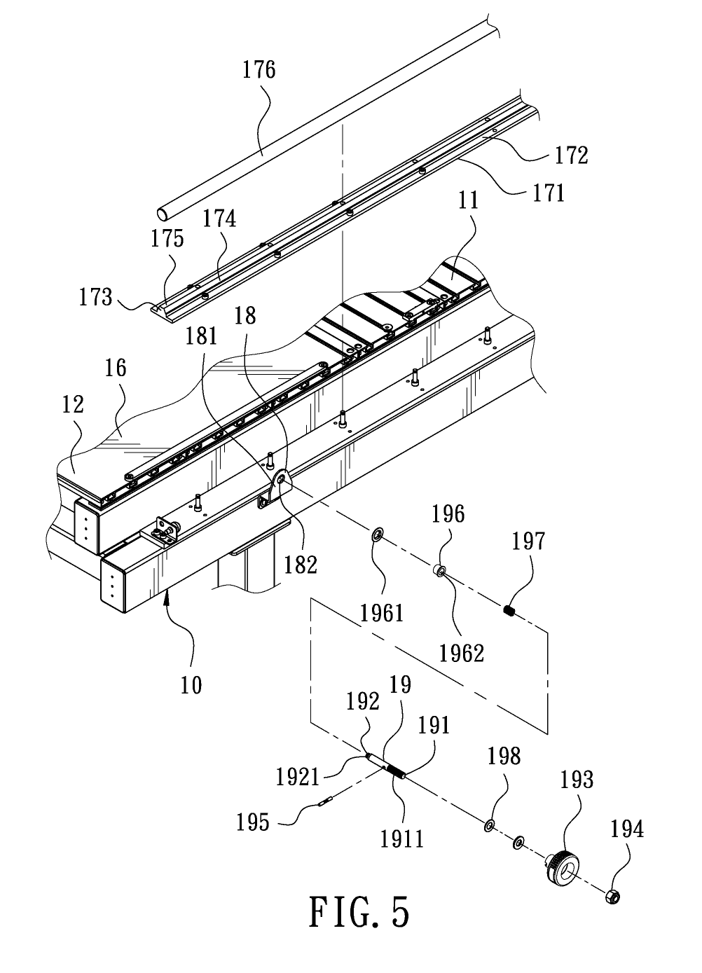

The fundamental base 10 is provided with a first working platform 11 and a second working platform 12 along an axis 101. The first working platform 11 and the second working platform 12 contain a plurality of wing plates 13 arranged adjacently. Referring to FIGS. 2 and 3, each wing plate 13 has two sides provided with a plurality of locking members 131 for the wing plates 13 to be fixed with the fundamental base 10 and each wing plate 13 contains plural plane parts 132, with a position-limiting groove 133 formed between every two plane parts 132. The plane parts 132 of the wing plates 13 of the first working platform 11 are provided with a plurality of first position-limiting members 14, which are respectively bored with at least one conical hole 141 corresponding to the position-limiting groove 133, and each conical hole 141 is received therein with a first operating member 142, which has a free end inserted through the conical hole 141 and located in the position-limiting groove 133 and further fixed thereon with a first resisting member 143. The second working platform 12 has the plane parts 132 of the wing plates 13 disposed with a plurality of second position-limiting members 15. Referring to FIG. 4, the second position-limiting members 15 are elongate position-limiting bars, respectively bored with at least one conical hole 151 corresponding to the position-limiting groove 133 for receiving a second operating member 152 therein. The second operating member 152 has a free end inserted through the conical hole 151 and located in the position-limiting groove 133 and further fixed with a second resisting member 153. A backing plate 16 is positioned between the second position-limiting members 15 and formed with a plurality of notches 161 respectively corresponding with the second operating members 152. In addition, the fundamental base 10 has two sides, parallel to the major axis 101, respectively provided with a guide unit 17. Referring to FIG. 5, the guide units 17 are respectively secured at two sides of both the first working platform 11 and the second working platform 12, and each guide unit 17 is provided with a plurality of guide rail seats 171 and a guide rail 176. Each guide rail seat 171 is provided with a plate body 172 to be fixed with the fundamental base 10. The plate body 172 has a central portion provided with a lengthwise projection 173, which has its topside formed with a conical part 174 having a free end provided with an arcuate recessed groove 175, and the guide rail 176 is received in the arcuate recessed groove 175. The fundamental base 10 is set with a positioning member 18 at a location adjacent to the second working platform 12. The positioning member 18 is formed with a positioning sheet 181 and a positioning rod 19, and the positioning sheet 181 has one end firmly fixed with the fundamental base 10 and another end bored with an insert hole 182. The positioning rod 19 to be inserted through the insert hole 182 of the positioning sheet 181 has two ends respectively formed with a first section 191 and a second section 192, which are respectively formed with a male thread 1911, 1921. The first section 191 is fitted thereon with a rotary knob 193 to be threadedly fixed with the first section 191 by a screw member 194 and the rotary knob 193 has a free end inserted with an insert pin 195, which is further inserted in the positioning rod 19, and the second section 192 of the positioning rod 19 is inserted out of the insert hole 182 of the positioning sheet 181. A positioning tube 196, a spring 197 and a blocking piece 198 are mounted between the first section 191 and the second section 192 of the positioning rod 19. The positioning tube 196 to be inserted in the insert hole 182 is fitted with an elastic piece 1961 facing the second section 192 and formed with a flaring edge 1962 facing the first section 191. The spring 197 has its fixed end pressing against the flaring edge 1962 and its elastic end elastically pushing against the blocking piece 198.

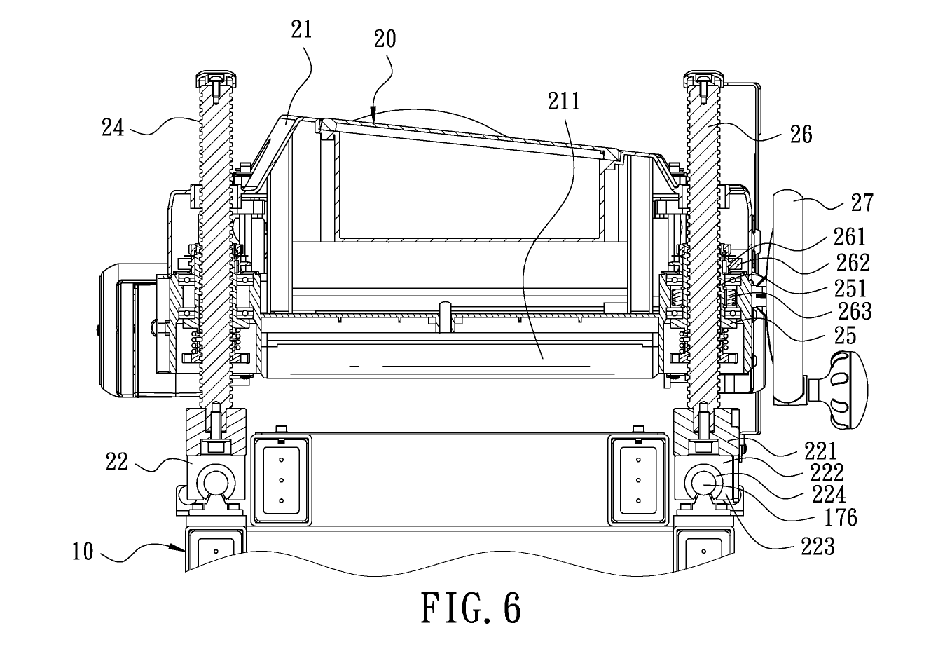

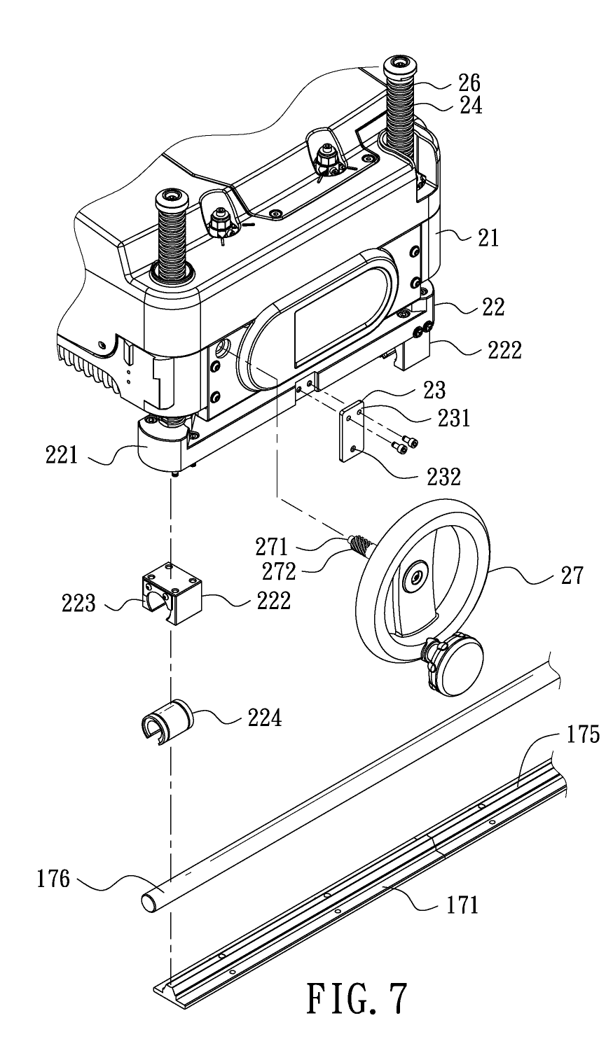

The wood planing device 20, referring to FIGS. 6 and 7, includes a housing 21, a moving member 22, a fixing member 23 and an adjustment unit 24. The housing 21 has its bottom side provided with a cutter arbor 211 corresponding with both the first working platform 11 and the second working platform 12. The moving member corresponding to the guide units 17 is positioned beneath the housing 21 and provided with a sliding-rail seat 221 and at least one bearing seat 222. The sliding-rail seat 221 has its topside connected with the housing 21 and has two ends of its underside respectively fixed with the bearing seat 222, which contains an arch sliding block 223 fitted with an arcuate bearing sleeve 224 to be mounted on the guide rail 176 of the fundamental base 10. The sliding-rail seat 221 is provided with the fixing member 23 corresponding to the positioning member 18 of the fundamental base 10, and the fixing member 23 is a fixing plate 231 bored with a fixing hole 232, which is a threaded hole. The second section 192 of the positioning rod 19 can be fixed with the fixing hole 232 so that the wood planing device 20 can be firmly positioned with the positioning member 18 of the fundamental base 10 through the fixing member 23. The adjustment unit 24 is installed with four lifting-rod seats 25 respectively located at four corners of the housing 21 and respectively formed with a female thread 251, and the four lifting-rod seats 25 are respectively connected with a lifting rod 26, which is a threaded rod. The lifting rods 26 respectively have one end firmly combined with the sliding-rail seat 221 and are respectively provided with a sprocket wheel 261, and the sprocket wheels 261 are collectively connected with a chain 262 and further, one of the lifting rods 26 is set with a lifting gear 263. The adjustment unit 24 is mounted with a hand wheel 27 at one side of the housing and the hand wheel 27 has a free end fixed with a regulating rod 271 provided with a male thread 272 corresponding to the lifting gear 263 to enable the regulating rod 271 to be threadedly engaged with the lifting gear 263. Thus, the hand wheel 27 can be operated to drive the lifting gear 263 to rotate through the regulating rod 271 and further actuate the sprocket wheels 261 to rotate by the chain 262 for regulating a height of the housing 21 and adjusting the spacing between the housing 21 and both the first working platform 11 and the second working platform 12.

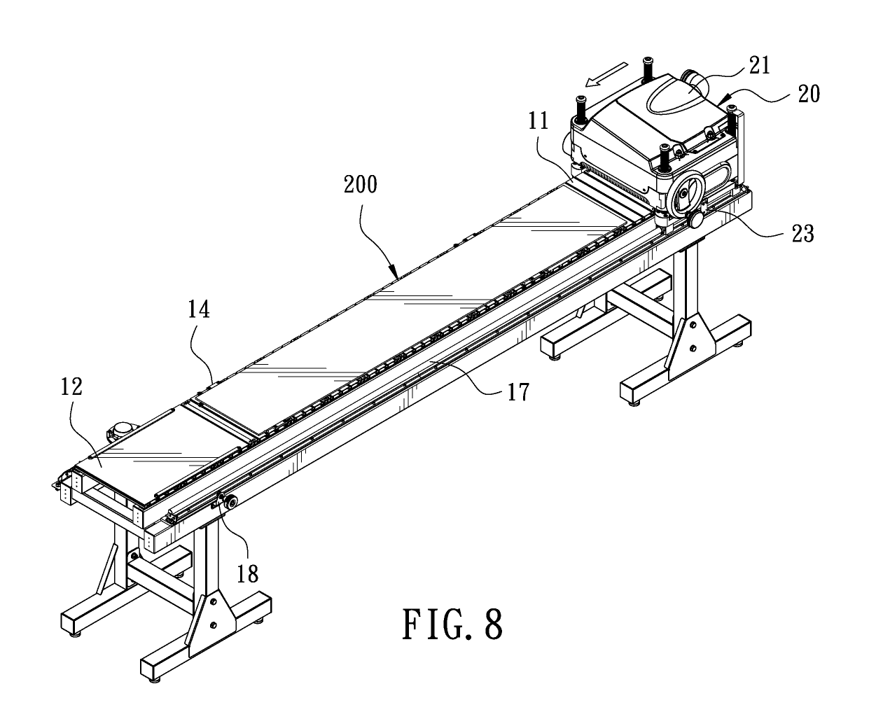

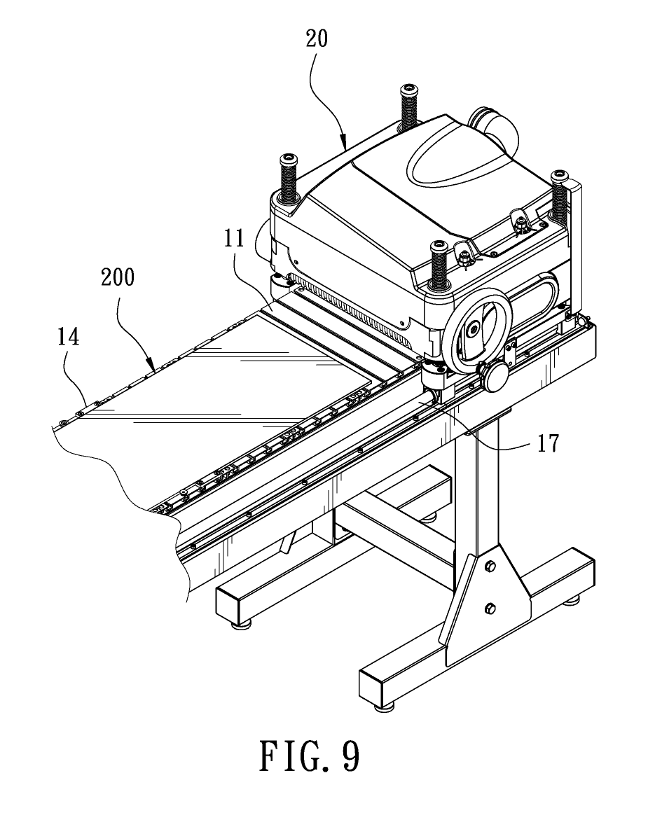

Referring to FIGS. 8 and 9, in use of the wood planing machine of this invention, firstly, the wood planing device 20 is moved to the first working platform 11, and a piece of wood 200 is placed on the first working platform 11 and restrictedly positioned at the first working platform 11 by the first position-limiting members 14. Next, the wood planing device 20 is moved toward the second working platform 12 along the guide units 17 and at this time, the warped side of the wood 200, corresponding with the wood planing device 20, will be planed off by the cutter arbor 211 to form a first flat surface as a criterion in the process of moving the wood planing device 20, rendering this invention having efficacy of a conventional hand press wood planer.

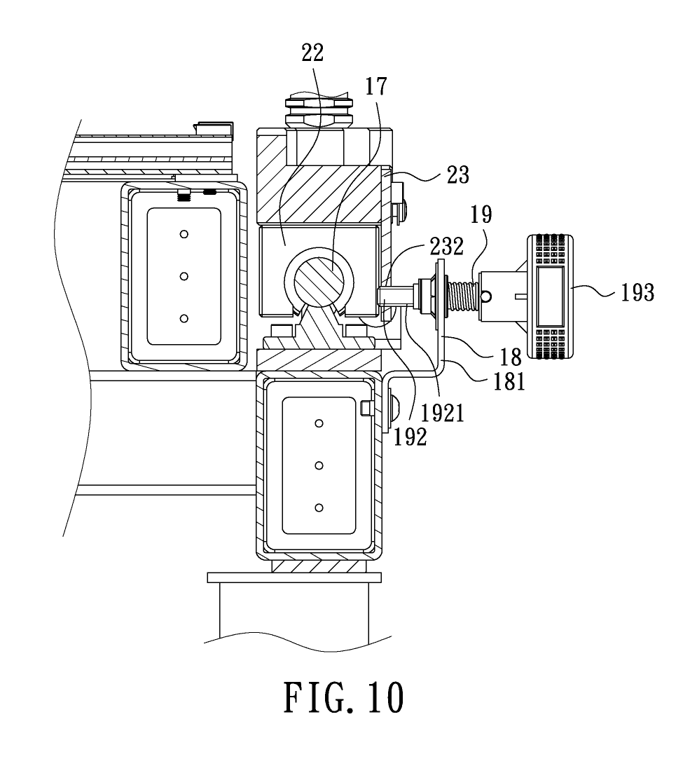

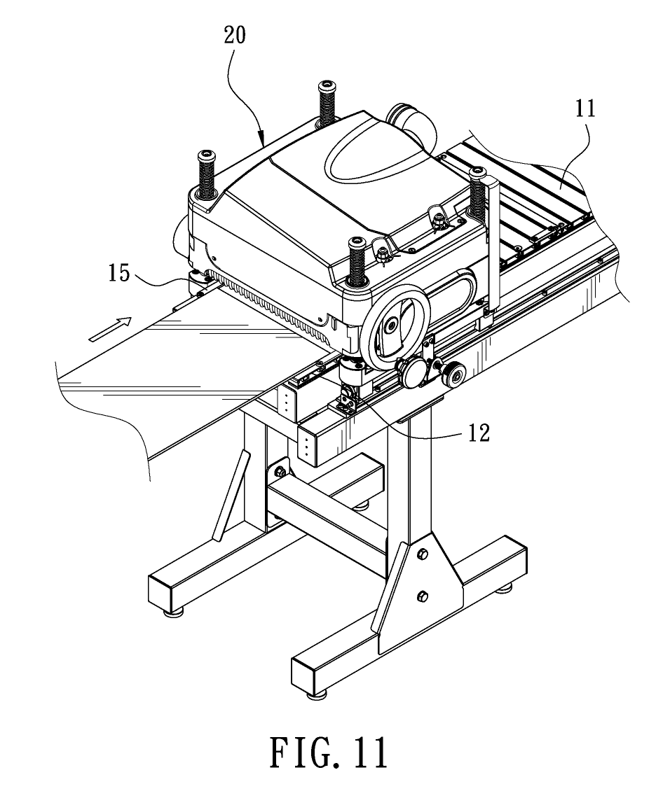

Subsequently, the fixing member 23 of the wood planing device 20 is actuated to correspond with the positioning member 18 of the fundamental base 10, and, referring to FIGS. 5, 7 and 10, the rotary knob 193 of the positioning member 18 is rotated toward the fixing member 23 to make the male thread 192 of the second section 192 threadedly combined with the fixing hole 232 of the fixing member 23 for positioning the wood planing device 20. Afterward, referring to FIGS. 1, 8 and 11, the wood 20 is turned over and placed the on the backing plate 16 of the second working platform 12 to have the wood 200 pushed toward the first working platform 11 from the second working platform 12. At this time, the wood 200 will be actuated to automatically move toward the first working platform 11 by the wood planing device 20 to have the warped portion of another side, which corresponds with the wood planing device 20, planed off by the cutter arbor 211 and forming a second smooth flat surface in the process of moving the wood planning device 200 for enhancing parallel precision of the first flat surface and the second flat surface of the wood 200, thus rendering this invention having efficacy of a conventional automatic wood planer.

One special feature of this invention is that this invention is able to integrate the efficacy of the conventional hand press wood planer and the conventional automatic wood planer; therefore, deformed and warped wood 200 can be flattened and smoothed by the wood planing machine 100 having manual and automatic planing wood function of this invention, able to elevate the parallel precision of the wood, reduce purchasing cost for consumers and simplify operation.

another special feature of this invention is that this invention is first to have the wood 200 positioned at the first working platform 11 by the first position-limiting members 14 and then push the wood planing device 20 to carry out wood planing operation; therefore, there is no danger of hurting hands as caused by the conventional hand press wood planer that needs a user's hands to press the wood, and there is no limitation of length and thickness for the wood 200 and further, the feeding end and the discharging end of the wood 200 are impossible to cause disparity. Moreover, the cutter arbor 211 is positioned over the wood 200 so it is impossible to cause a problem of spring back of the wood 200, thus increasing safety in operation.

The other special feature of this invention is that a user can make use of the adjustment unit 24 to regulate the spacing between the housing 21 and both the first working platform 11 and the second working platform 12; therefore, a planing thickness of the wood 200 can be preset simply.

While the preferred embodiment of this invention has been described above, it will be recognized and understood that various modifications may be made therein and the appended claims are intended to cover all such modifications that may fall within the spirit and scope of the invention.

What is claimed is:

1. A wood planing machine having both manual and automatic planing wood function comprising:
a fundamental base provided with a first working platform and a second working platform along a major axis, said fundamental base having two sides, which are parallel to said major axis, respectively provided with a guide unit, said fundamental base provided with a positioning member at location adjacent to said second working platform; and
a wood planing device comprising a housing, a moving member and a fixing member, said housing having a bottom side installed with a cutter arbor corresponding to both said first working platform and said second working platform, said moving member assembled beneath said housing to correspond with said guide units of said fundamental base, said moving member provided with said fixing member to correspond with said positioning member of said fundamental base, said positioning member of said fundamental base able to be positioned with said fixing member to enable said wood planing device to be positioned at said positioning member of said fundamental base by said fixing member.

2. The wood planing machine having both manual and automatic planing wood function as claimed in claim 1, wherein said first working platform and said second working platform comprise a plurality of wing plates arranged adjacently, each said wing plate having two sides provided with plural locking members for said wing plates to be fixed with said fundamental base, each said wing plate comprising plural plane parts, a position-limiting groove formed between every two said plane parts.

3. The wood planing machine having both manual and automatic planing wood function as claimed in claim 2, wherein said plane parts of said wing plates of said first working platform are set with a plurality of first position-limiting members, each said position-limiting member bored with at least one conical hole corresponding to said position-limiting groove, each said conical hole received therein with a first operating member, said first operating member having a free end inserted through said conical hole and located in said position-limiting groove, said first operating member having the free end fixed with a first resisting member.

4. The wood planing machine having both manual and automatic planing wood function as claimed in claim 2, wherein said plane parts of said wing plates of said second working platform are provided with plural second position-limiting members, said second position-limiting members being elongate position-limiting bars, each said second position-limiting member formed with at least one conical hole corresponding with said position-limiting groove, said conical hole received therein with a second operating member, said second operating member having a free end inserted out of said conical hole and located in said position-limiting groove, said second operating member having the free end mounted with a second resisting member, a backing plate assembled between said second position-limiting members, said backing plate formed with plural notches respectively corresponding to said second operating members.

5. The wood planing machine having both manual and automatic planing wood function as claimed in claim 1, wherein said guide units are respectively arranged at two sides of both said first working platform and said second working platform, each said guide unit disposed with plural guide rail seats and a guide rail, each said guide rail seat formed with a plate body to be firmly fixed with said fundamental base, said plate body having a central portion provided with a lengthwise projection, said projection having a topside formed with a conical part, said conical part having a free end formed with an arcuate recessed groove, said guide rail received in said arcuate recessed groove.

6. The wood planing machine having both manual and automatic planing wood function as claimed in claim 1, wherein said moving member is provided with a sliding-rail seat and at least one bearing seat, said sliding-rail seat having a topside connected with said housing, said sliding-rail seat having two ends of an underside respectively fixed with said bearing seat, said bearing seat comprising an arch sliding block, said sliding block fitted with an arcuate bearing sleeve, said bearing sleeve mounted around said guide rail of said fundamental base.

7. The wood planing machine having both manual and automatic planing wood function as claimed in claim 1, wherein said positioning member has a positioning sheet and a positioning rod, said positioning sheet having one end secured with said fundamental base, said positioning sheet having another end bored with an insert hole, said positioning rod inserted through said insert hole of said positioning sheet.

8. The wood planing machine having both manual and automatic planing wood function as claimed in claim 7, wherein said positioning rod has two ends respectively formed with a first section and a second section, said first section and said second section respectively provided with a male thread, said first section fitted thereon with a rotary knob, said rotary knob threadedly fixed with said first section via a screw member, said rotary knob having a free end inserted with an insert pin, said insert pin further inserted in said positioning rod, said second section of said positioning rod inserted through said insert hole of said positioning sheet, a positioning tube, a spring and a blocking piece mounted between said first section and said second section of said positioning rod, said positioning tube inserted in said insert hole, said positioning tube fitted with an elastic piece facing said second section, said positioning tube provided with a flaring edge facing said first section, said spring having a fixed end resisting against said flaring edge, said spring having an elastic end pressing against said blocking piece.

9. The wood planing machine having both manual and automatic planing wood function as claimed in claim 8, wherein said fixing member is a fixing plate and said fixing member is bored with a fixing hole, which is a threaded hole, said second section of said positioning rod positioned in said fixing hole of said fixing member, said wood planing device able to be positioned with said positioning member of said fundamental base through said fixing member.

10. The wood planing machine having both manual and automatic planing wood function as claimed in claim 1, wherein said wood planing device further comprises an adjustment unit, said adjustment unit provided with four lifting-rod seats respectively located at four corners of said housing, said lifting-rod seats respectively formed with a female thread, said lifting-rod seats respectively connected with a lifting rod, said lifting rod having one end firmly fixed with said moving member, said lifting rods respectively provided with a sprocket wheel, said sprocket wheels collectively connected with a chain, one of said lifting rods provided with a lifting gear, said adjustment unit installed with a hand wheel at one side of said housing, said hand wheel having a free end formed with a regulating rod, said regulating rod provided with a male thread corresponding with said lifting gear, said regulating rod threadedly combined with said lifting gear, said hand wheel operated to drive said lifting gear to rotate by said regulating rod and then actuate said sprocket wheels to rotate through said chain to regulate a height of said housing for adjusting spacing between said housing and both said first working platform and said second working platform.
